(19) United States
(12) Patent Application Publication
(10) Pub. No.: US 2023/0322462 A1
(43) Pub. Date: Oct. 12, 2023

(54) RECYCLE-READY LIDDING FILM

(71) Applicant: AMCOR FLEXIBLES NORTH AMERICA, INC., Neenah, WI (US)

(72) Inventors: Florian CHAPALAIN, Marcq-en-Baroeul (FR); Peter Ettridge, Worcester (GB); Helmar Utz, Koppigen (CH); Roy Christopherson, Shrivenham (GB)

(21) Appl. No.: 18/027,057

(22) PCT Filed: Oct. 8, 2020
(86) PCT No.: PCT/US2020/054694

§ 371 Date: Mar. 17, 2023

(51) Int. Cl. B65D 77/20; B32B 27/32; B32B 27/08; C08J 7/04; C08J 7/048; C08J 7/052

(52) U.S. Cl. CPC B65D 77/2032; C08J 2423/12; B32B 27/08; C08J 7/0423; C08J 7/048; C08J 7/052; B32B 2307/518; B32B 2307/748; B32B 2307/31; B32B 2435/02; B32B 2250/242; B32B 2264/1021; B32B 2307/5825; B32B 2307/7244; B32B 2307/308; C08J 2323/12; B32B 27/32

(57) ABSTRACT

A laminated polypropylene-based film suitable for use as a lidding film having an exterior film, a barrier layer, and a sealing layer. The lidding film has a total composition including high levels of polyolefin-based polymers and polypropylene-based polymers such that the material can be processed efficiently in a polypropylene recycling process. Advantageously, the film retains the properties required to suitably withstand sterilization and pasteurization processes and produce a high-quality packaged product.

### TECHNICAL FIELD

This disclosure is related to film structures, specifically lidding films and the packaged products made therefrom. The lidding films described herein may be recyclable in a polyolefin-based stream.

### BACKGROUND

A variety of preservation processes are used in the packaging industry to create safe food and healthcare products with an extended shelf-life. Some processes sterilize the product and/or packaging components by heat, chemical means, high-pressure, irradiation or a combination of these, having the effect of killing all microorganisms and their spores. Some processes pasteurize a food product using heat, having the effect of reducing the microbial load. The preservation process, e.g., sterilization or pasteurization, is carried out either just prior to filling and sealing the package or after the package has been filled and sealed. Examples of these processes include, but are not limited to, retort/autoclave processing, high-pressure pasteurization (HPP), hot fill, aseptic sterilization, and irradiation. These processes impose a high-temperature, high-pressure or otherwise harsh environment to the packaging material.

Specialized flexible packaging films are designed for applications that incorporate these harsh preservation processes. Flexible packaging films used for pasteurization or sterilization applications often have many different layers, each layer contributing one or more attributes for enduring the harsh conditions. For example, the packaging films may require high stiffness and high heat resistance to work well in a high-speed packaging process. In other examples, the packaging films are designed to withstand the high temperatures and pressure changes of the sterilization process without losing seal integrity, without losing appropriate levels of gas barrier properties or becoming unappealing in appearance.

A typical flexible packaging film intended for a sterilized or pasteurized (i.e. preserved) product application may include a combination of materials such as polyester or polyamide, providing excellent heat resistance, dimensional stability, and stiffness; aluminum foil, providing high barrier and stiffness; and/or polyolefins providing suitable sealing characteristics. Unfortunately, when this wide variety of materials is combined in a single packaging film, the film becomes difficult to recycle.

Many consumers and consumer goods packagers desire to use recyclable food packaging (i.e. recycle-ready). In some cases, recyclable packaging structures are desirable for compliance purposes. Without any additional compatibilizing chemicals, however, materials such as polyester, polyamide and foil may not be recyclable in current recycling streams for flexible packaging. Additionally, structures that contain metal are generally not suitable for applications where the consumer may desire to heat the product in the packaging using a microwave.

There is a continuing need for high-performance films that are recyclable while also providing excellent mechanical properties and heat resistance to meet the demands of high-performance packaging.

### SUMMARY

Described herein are flexible packaging films that can be used as lidding in pasteurization or sterilization applications, advantageously being recyclable in a polyolefin recycling stream. Despite having a composition with a high polyolefin content, the lidding film retains the characteristics that allow it to function well in high-speed packaging operations and survive the harsh sterilization/pasteurization cycle while retaining good appearance, excellent barrier properties and hermetic integrity.

The lidding films herein include: an exterior polypropylene-based film, a barrier layer, and a sealing layer. The lidding film has a total composition comprising at least 80% polyolefin-based polymers by weight.

The lidding film may have an exterior polypropylene-based film that is oriented. The exterior polypropylene-based film may be made of a homopolymer polypropylene.

The lidding film may have a barrier layer including a metal. The lidding film may have a barrier layer including an inorganic oxide.

In some embodiments, the lidding film has a total composition comprising at least 80% polypropylene-based polymers by weight. The lidding film may have a total composition comprising at least 90% polyolefin-based polymers by weight.

The lidding film may have a sealing layer that is a peelable sealing layer. The lidding film may have a sealing layer including a polypropylene-based polymer.

The lidding film may further include an interior polypropylene-based film and the interior polypropylene-based film may be oriented.

The packages disclosed herein include: the lidding film, a second packaging component, a heat seal connecting the sealing layer of the lidding film to a surface of the second packaging component and a product hermetically sealed between the lidding film and the second packaging component. In some embodiments, the product has undergone a sterilization process. In some embodiments the product has undergone a pasteurization process. In some embodiments the lidding film has undergone a sterilization process. In some embodiments the lidding film has undergone a pasteurization process.

The package may include a heat seal that is manually peelable.

The package may have a second packaging component having a surface comprising a polypropylene-based polymer.

In some embodiments the package has a total composition having at least 80% polyolefin-based polymers, by weight. In some embodiments the package has a total composition having at least 80% polypropylene-based polymers, by weight. In some embodiments the package has a total composition having at least 90% polypropylene-based polymers, by weight.

The package may include a lidding film having an oxygen transmission value less than 3.0 cc/m² day when measured according to ASTM F1927 at conditions of 23° C. and 50% RH.

### BRIEF DESCRIPTION OF THE DRAWINGS

The disclosure may be more completely understood in consideration of the following detailed description of various embodiments of the disclosure in connection with the accompanying drawings, in which:

FIG. 1 is a plan view of an embodiment of a package incorporating a lidding film;

FIG. 2 is a schematic side view of an embodiment of a lidding film;

FIG. 3 is another schematic side view of an embodiment of a lidding film;

FIG. 4 is another schematic side view of an embodiment of a lidding film; and

FIGS. 5 through 8 are heat seal curves for Example and Comparative Example Films as discussed in the Examples & Data section.

The drawings show some but not all embodiments. The elements depicted in the drawings are illustrative and not necessarily to scale, and the same (or similar) reference numbers denote the same (or similar) features throughout the drawings.

### DETAILED DESCRIPTION

Current flexible packaging films designed to provide high performance in demanding applications contain a multitude of different materials. The structures commonly contain layers that include polyester, polyamide, polyethylene, polypropylene, metal and/or ethylene vinyl alcohol copolymer. Each layer of the structure is designed to offer properties such as barrier, stiffness, heat resistance, dimensional stability, puncture resistance, seal strength, and visual appeal, to name a few. The challenging functionality requirements of sterilized or pasteurized product packaging and the diversity of materials in the current structures pose a major hurdle when looking to provide a more sustainable packaging solution, one that is recyclable.

Design of lidding films becomes challenging due to the high demands of these applications as compared to other flexible packaging formats. The heat-sealing equipment used to apply lidding films to rigid containers (i.e. cups, trays, plates, etc.) typically only direct heat from the lidding side. Additionally, it becomes more challenging to create a heat seal to a rigid packaging component that typically has a rougher sealing surface. The process of applying the lid to the package includes a process using high heat, short dwell times and high pressure. Thus, the lid experiences significantly higher heat as compared to sealing operations that heat seal two flexible films together. Typical flexible lidding structures are designed with high temperature resistant materials to survive the heat-sealing process without showing signs of degradation such as marring, sticking or melting. In particular, materials such as polyester or polyimide are used as the exterior material for the lidding film to provide enough heat resistance.

When moving to recyclable structures (i.e. those that are based on polyolefin materials), lidding films are at higher risk to reach a point where the film begins to burn or distort prior to achieving a solid hermetic seal. Considering this, it was an unexpected discovery for the inventors to develop a lidding film structure for products that utilize a sterilization or pasteurization process. Specifically, it was surprising to be able to use an exterior layer of the film structure including high levels of polyolefin that exhibited enough heat resistance to 1) show minimal or no signs of heat distortion and 2) provide enough protection to the barrier layer such that it is not damaged during heat sealing.

Additionally, the lidding film is effective to survive a preservation process (i.e. pasteurization or sterilization). To be effective to survive a preservation process, the lidding structure must provide enough protection to the barrier layer such that the barrier provided does not diminish significantly after the preservation process. Specifically, the oxygen barrier of the lidding film should not be more than 3.0 cc/m² day after exposure to retort conditions. Another characteristic of a lidding film that is effective to survive a preservation process is that the lid maintains a good heat seal (i.e. does not leak or become weak) to the other packaging components after the preservation process.

As disclosed herein, a lidding film has been designed comprising high levels of polyolefin-based materials, specifically, high levels of polypropylene-based materials. Despite the elimination of many of the materials commonly used in lidding (i.e. polyester, polyamide, aluminum foil), the structure retains adequate attributes of barrier, heat resistance, appearance and seal integrity. Advantageously, the structure is suitable for recycling in a polyolefin-based mechanical recycling process due to the low levels of materials that are not polyolefin in nature.

Specifically surprising is the achievement of a lidding film has both a design such that the sealing layer has a heat seal initiation temperature that is low enough to match the only moderate heat resistance of the exterior surface provided by the polyolefin materials and a sealing layer with enough integrity to survive the high temperatures of a sterilization/pasteurization process along with other abuses a package may endure during distribution and use. The lidding film can be formed into packages at lower sealing temperatures, retaining excellent visual appearance. Additionally, the packaging structure maintains excellent barrier properties and seal integrity, even after the film has been formed into a package, filled with a product, hermetically sealed and undergone a sterilization/pasteurization process.

In one or more embodiments, the lidding films described herein contain at least 80% polyolefin-based polymers by weight, and at least 50% polypropylene-based polymers, by weight. Materials that are not polyolefin-based polymers are minimized. In one or more embodiments, non-polyolefin-based polymers are less than 20% by weight of the total lidding composition, including less than 10% by weight, less than 5% by weight, or even less than 1% by weight. In one or more embodiments, non-polyolefin-based polymers are excluded from the total lidding composition. The exterior surface of the lidding film has a heat-resistant polypropylene-based film. The interior surface of the lidding film has a sealing layer that is a polypropylene-based blend of polymers. The lidding film contains a barrier layer that is generally not a polyolefin-based material. The film may also have other materials such as adhesives, inks and coatings.

Using the lidding film design elements as described herein, a recyclable lidding film can be achieved. The films are suitable to be recycled in a polyolefin-based recycling process because of the high polyolefin content. The films are also suitable to be recycled in a polypropylene-based recycling process because of the high polypropylene content. Specifically, the films may have low levels of, or may be free from materials such as polyester, polyamide, chlorine containing polymers and aluminum foil. As used herein “aluminum foil” is a web of metal having a thickness of at least 1 micron, typically more than 5 microns. The films may contain non-polyolefin-based polymers such as those used in adhesive layers or ink layers, but these are minimized and generally less than 10% of the overall composition, by weight. The films may contain non-polymeric materials such as barrier materials, but these are minimized and generally less than 10% of the overall composition, by weight.

### Package

Described herein are packaging films and lidding films suitable for preservation processes, e.g., sterilized or pasteurized packaging applications, as well as the packages made therefrom. As used herein, a sterilization or pasteurization process is one that eliminates or reduces the microbial load of the product and/or the packaging material such that the packaged product has an extended shelf life. The process may occur prior to filling the package, during filling of the package or after the package is filled with the product and hermetically sealed. The lidding film withstands the abusive processes and maintains excellent performance including, but not limited to, barrier properties and appearance.

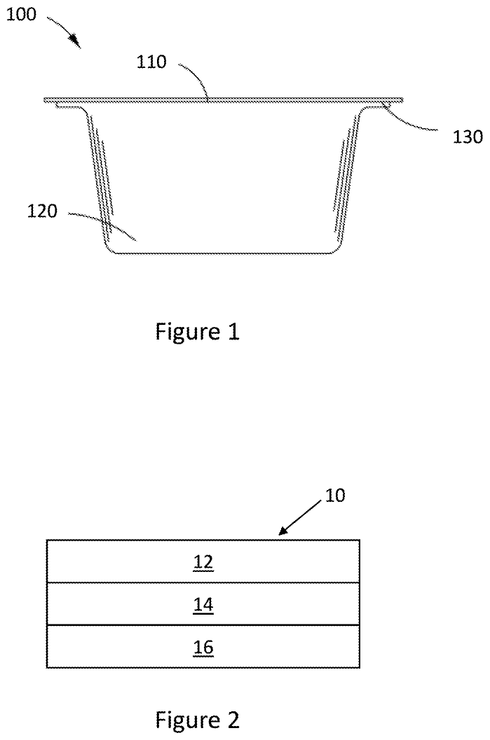

The package includes at least one heat seal to allow for connection of the lidding film to another packaging component, formation of the package and hermetic closure of the package. An example of a package 100 that includes a lidding film 110, a second packaging component 120 and a heat seal 130 is shown in FIG. 1. The heat seal 130 connects the sealing layer of the lidding film 110 to a surface of the second packaging component 120, with the product hermetically sealed between the lidding film and the second packaging component.

The heat seal hermetically closes the package, protecting the product from contamination and preventing leaks. The heat seal withstands any abuses of the package during distribution such as stacking, shipping vibration, pressure fluctuations, dropping, etc. For convenience, the heat seal may be ruptured by manual force such as a consumer peeling the lidding film away from the second packaging component.

A package may be made entirely of a lidding film as described herein and a second packaging component. The second packaging component may be a cup, a tray, a plate or a bowl and has one or more cavities for holding the product. The package may also include other components including but not limited to labels, absorbers and dividers. Any components of the package that are not the lidding films described herein (i.e. second packaging component) may also have high levels of polypropylene polymer. In some embodiments of the package, the second packaging component has at least 90% polypropylene-based polymer, by weight, such that the entire package (i.e. the lidding film and all other packaging components) is recyclable in the polypropylene recycling process.

The lidding film may be sealed to the second packaging component by a heat seal that has excellent integrity yet is manually peelable. When used herein, a seal is “manually peelable” when the two items attached by said heat seal can be separated by pulling with hand strength and the packaging components separate at or near the heat seal. In other words, a consumer can remove the lidding film and/or access the contents of the package by way of their own force separating the packaging components without the use of a tool such as scissors nor without tearing the packaging materials.

In some embodiments of the package, some components of the package are not recyclable in the polyolefin or polypropylene recycling processes. In that case the packaging components may be separated prior to recycling and/or disposal. Separation of the packaging components may be by manually peeling the heat seals.

In some embodiments of packages formed from a lidding film, the package has at least 90% polyolefin-based materials or at least 80% polyolefin-based materials, by weight. In some embodiments of packages formed from a lidding film, the package has at least 90% polypropylene-based materials or at least 80% polypropylene-based materials, by weight. In some embodiments of packages formed from a lidding film, the package has at least 90% polyolefin-based materials and at least 80% polypropylene-based materials, by weight.

In some embodiments of the packages, the surface of the second packaging component includes a polypropylene-based polymer. When both the sealing layer of the lidding film and the surface of the second packaging component to which the lidding film is sealed include polypropylene-based polymers, a high integrity heat seal may be formed.

### Lidding Film

Described herein are lidding films suitable for packaging as well as the packages and shelf-stable packaged products made therefrom. As used herein, a “lidding film” is a film that could be used in a flat state to cover the opening in another packaging component such as a cup or tray. That cup or tray may be filled with a product, sealed with the lidding film, and remain hermetically sealed throughout the shelf-life of the packaged product. The lidding film may be exposed to abusive conditions as a result of sterilization or pasteurization process applied to one or all the packaging components, to the product or to the hermetically sealed packaged product. Because the sterilization/pasteurization process is harsh, very specialized lidding films have been designed to survive the process, maintaining excellent barrier, good appearance, and seal integrity.

Various types of packaging materials can be used in sterilization processes, including cans, jars and flexible polymeric-based packaging, such as the lidding films and laminated polypropylene-based films described herein. The advantages of using flexible packaging such as the lidding films described herein include weight reduction and a reduction in the energy required to get the contents of the package to the conditions at which the sterilization occurs. A lidding film may have a thickness from about 2.5 mil (63.5 micron) to about 10 mil (254 micron), or from about 3 mil (76.2 micron) to about 6 mil (152.4 micron).

Referring now to FIG. 2, an embodiment of the lidding film 10 includes an exterior polypropylene-based film 12, a barrier layer 14 and a sealing layer 16. The exterior polypropylene-based film 12 is located on one major surface of the lidding film and becomes the exposed outside surface of a package to which the lidding film is connected. In some cases, the exterior polypropylene-based film 12 has an ink or another coating applied to the exposed surface. The sealing layer 16 is located on the other major surface of the lidding film and becomes the product contact side when the lidding film is formed into a package. The sealing layer 16 is necessarily on a surface such that a heat seal can connect the sealing layer to another packaging component. The barrier layer 14 is located interior to the surfaces of the lidding film. The lidding film has a total composition including at least 80% polyolefin-based polymers, by weight. The lidding film has a total composition including at least 90% polypropylene-based polymers, by weight.

As used herein, a “layer” is a homogeneous building block of films. Layers may be continuous or discontinuous (i.e. patterned) with the length and width of the film. As used herein the term “film” is a mono-layer or multi-layer web that has an insignificant z-direction dimension (thickness) as compared to the x- and y-direction dimensions (length and width), not unlike a piece of paper. Films are generally regarded as having two major surfaces, opposite each other, expanding in the length and width directions. Films may be built from an unlimited number of films and/or layers, the films and/or layers being bonded together to form a composite article. A portion of a packaging film may be referred to as a layer or a film.

The lidding film contains at least one polypropylene-based film. As used herein, a “polypropylene-based film” has a composition including at least 50%, or at least 90% polypropylene-based polymer, by weight. In some cases, the polypropylene-based film may be essentially 100% polypropylene-based polymer.

The exterior polypropylene-based film may be oriented. As used herein, the term “oriented” indicates that the film has been heated to a temperature lower than the melting point of the material and stretched at least 2×. This is typically accomplished by a double- or triple-bubble process, by a tenter-frame process or an MDO (machine direction orientation) process using heated rolls. A typical blown film or cast film process does impart some stretching of the film, but not enough to be considered oriented as described herein. The film may be biaxially oriented or mono-axially oriented in either direction. The exterior polypropylene-based film is preferably heat set (i.e. annealed) after orientation, such that it is dimensionally stable under elevated temperature conditions that might be experienced during conversion of the lidding film (i.e. printing or laminating) or during the use of the lidding film (i.e. heat sealing or retort sterilization). The exterior polypropylene-base film may be produced using specific polymers and may be oriented using specific conditions which optimize the heat resistance of the film. The exterior polypropylene-based film may include homopolymer polypropylene or may be made entirely of homopolymer polypropylene.

The exterior polypropylene-based film may be an oriented polypropylene film, such as biaxially oriented polypropylene. The oriented polypropylene film may have one or more layers and may have specialized coatings, such as matte lacquer. Any of the layers of the oriented polypropylene film may contain a pigment, such as titanium dioxide, to make the film opaque to visible light. The film may be a cavitated biaxially oriented polypropylene, resulting in a film opaque to visible light. The biaxially oriented polypropylene may be clear to visible light. In some embodiments, the exterior polypropylene-based film is a biaxially oriented polypropylene film that essentially comprises polypropylene. The exterior polypropylene-based film may have, but is not limited to, a thickness of about 12, about 20, about 25 or about 30 microns.

Commercial examples of films that may be used as the exterior polypropylene-based film include Bicor™ NND20 (non-heat sealable, one side treated BOPP, available from Jindal Films), PL1 (non-heat sealable, one side treated BOPP, available from Polibak Plastik Film San. ve Tic. A.S.) and PPTE_LAM (non-heat sealable, one side treated, available from Poligal).

As used herein, the term “exterior” is used to describe a film or layer that is located on one of the major surfaces of the film in which it is comprised. As used herein, the term “interior” is used to describe a film or layer that is not located on the surface of the film in which it is comprised. An interior film or layer is adjacent to another film or layer on both sides.

The barrier layer of the lidding film is generally coextensive with the lidding film and contains a barrier material. The barrier layer provides for reduced transmission to gases such as oxygen (i.e. containing an oxygen barrier material). The barrier layer may additionally provide reduced transmission to moisture (i.e. containing a moisture barrier material). The barrier layer is typically an interior layer of the lidding film to protect the integrity of this layer. The barrier material may be polymeric in nature, such as polyamide, ethylene vinyl alcohol copolymer or polyvinyl alcohol copolymer. The barrier material may be metallic, such as a thin deposition of aluminum. The barrier layer may be transparent inorganic oxide coating such as AlOx or SiOx. The barrier layer may be multi-layer and contain different layers of barrier materials. The barrier layer may be a blend of multiple barrier materials. The barrier layer provides the specific barrier required to preserve the product within a package throughout an extended shelf-life which may be several months or even more than one year.

The barrier layer may be located on a surface of the exterior polypropylene-based film. In some embodiments of the lidding film, the barrier layer is located on the interior surface of the exterior polypropylene-based film facing the sealing layer. Alternatively, the barrier layer may be deposited on a surface of an interior film.

The barrier layer reduces the influx of oxygen through the lidding film during the shelf-life of the packaged product (i.e. while the package is hermetically sealed). In some embodiments, before being exposed to a pasteurization or sterilization process, the lidding film has an average oxygen transmission rate (OTR) value that is less than 2 cm³/m²/day, less than 1 cm³/m²/day, less than 0.5 cm³/m²/day, or less than 0.1 cm³/m²/day (measured according to ASTM F1927 using conditions of 1 atmosphere, 23° C. and 50% RH). In some embodiments, after being exposed to a pasteurization or sterilization process, the lidding film has an average OTR value that is less than 2 cm³/m²/day, less than 1 cm³/m²/day, less than 0.5 cm³/m²/day, or less than 0.1 cm³/m²/day. The average OTR value may be near, at or below the minimum detection level of a testing device.

The sealing layer of the lidding film has a composition that will allow the formation of a heat seal, thus forming a hermetic package. As used herein, the term “heat sealed” or “heat sealing” refers to the connecting of two or more surfaces by application of both heat and pressure for a short period of time, or by way of an ultrasonic energy sealing process. As used herein, the term “heat seal” refers to the connection between the two or more surfaces made by heat sealing. Heat sealing and ultrasonic sealing are well-known and commonly used processes for creating packages and are familiar to those skilled in the art.

The sealing layer of the lidding film may be a peelable sealing layer having a composition that will render the heat seal formed as manually peelable. There are various mechanisms under which the peeling may occur, including adhesive failure or cohesive failure. Under any mechanism, the peeling and separating of the packaging components occurs at or near the heat seal connecting the lidding film to another packaging component. A sealing layer and/or a lidding film can be tested for forming a manually peelable heat seal by sealing the film to itself (i.e. sealing layer to sealing layer) using heat sealing conditions of 150° C., 1 second, 30 psi and measuring the force to separate the films by ASTM F88 (grip separation at 100 mm/min). The seal is manually peelable if the maximum force to separate is less than 20 N/15 mm.

The sealing layer is necessarily on the surface of the lidding film, thus facilitating the function of sealing. During heat sealing, the sealing layer softens, allowing formation of a heat seal bond, at a sealing temperature that is lower than the temperature resistance of the exterior polypropylene-based film. The sealing layer softens at a sealing temperature that is lower than the temperature resistance of the exterior oriented film. The sealing layer should soften and form a heat seal at sealing conditions (time, temperature and pressure) that do not cause excessive shrinking or marring on the exterior surface of the lidding film.

The lidding film is targeted to contain high amounts of polyolefin-based polymers, specifically polypropylene-based polymers, such that it may be acceptable for a recycling process. Polyolefins have relatively low heat resistance as compared to materials traditionally used for pasteurized or sterilized packaging film applications (i.e. polyester, aluminum foil, polyamide). As a result of the high polyolefin content and the lower heat resistance, the packages must be formed using a heat-sealing process with lower temperatures to avoid any shrinking or burn through. The challenge met by the lidding films disclosed herein is to incorporate a sealing layer that has a low heat-seal initiation temperature (HSIT) and high seal strength and seal toughness to survive both processing and normal distribution and handling (i.e. drop strength and burst strength). The sealing layer must also contain materials that are approved for food contact during conditions of use, as dictated by governmental agencies for food safety.

The sealing layer may contain a material that has a low heat seal initiation temperature (HSIT). In some embodiments of the lidding film, the sealing layer contains a polypropylene copolymer having a melt temperature equal to or less than 135° C.

The sealing layer may be formed by any known process. For example, the sealing layer may be a heat seal lacquer that is coated onto the other layers of the lidding film. In other embodiments, the sealing layer is formed by an extrusion process that applies a polymer melt directly to the other layers of the lidding film. In yet other embodiments, the sealing layer may be formed in an off-line coextrusion process (i.e. a cast film or blown film process) and subsequently adhered to the other layers of the lidding film using a lamination process. The sealing layer may be comprised within a multilayer film containing 2, 3, 4 or more layers. In some embodiments, the sealing layer is a non-oriented layer.

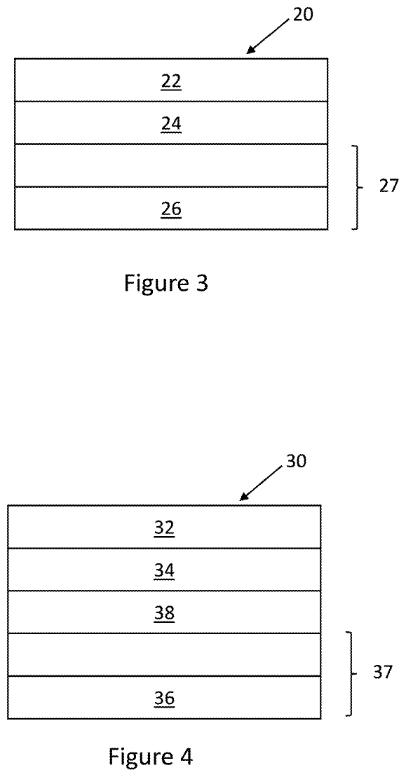

Referring now to FIG. 3, an embodiment of the lidding film 20 includes an exterior polypropylene-based film 22, a barrier layer 24, and a sealing layer 26. The sealing layer 26 is within a coextruded multilayer film 27. The exterior polypropylene-based film 22 may be located on one major surface of the lidding film and becomes the exposed outside surface of a package that may be formed from the lidding film. The sealing layer 26 is located on the other major surface of the lidding film and becomes the product contact side of a hermetically sealed package that may be formed from the lidding film. The barrier layer 24 is located interior to the surfaces of the lidding film 20. The lidding film has a total composition including at least 80% polyolefin-based polymers, by weight. The lidding film may have a total composition including at least 90% polypropylene-based polymers, by weight.

While the structure of the lidding film and any packages made therefrom contain several different elements (exterior layer, barrier layer, sealing layer, etc.) the total composition of the film or package should have high levels of a single material type (polyolefin or specifically, polypropylene) to facilitate recycling. As used herein, the term “total composition” is used to describe the entire lidding film structure or package. Any materials, layers or components that are connected to one another in any way are part of the total composition of that article. The lidding film may have high levels of polyolefin-based polymers. The lidding film may have high levels of polypropylene-based polymers. The lidding films described herein, and any packages made therefrom, may be recyclable in a polypropylene recycling process when the article contains high amounts of polypropylene-based polymers. A mixed polyolefin recycling process can also accept relatively high levels of polyolefins that are not polypropylene, so the articles may also contain high levels of polyolefins that are not polypropylene and still be suitable for recycling.

As used herein, a “polyolefin-based polymer” refers to a homopolymer or copolymer having at least one alkene monomer linkage within the repeating backbone of the polymer. Primary examples of polyolefin-based polymers are polyethylene homopolymers and copolymers and polypropylene homopolymers and copolymers. Other examples of polyolefin-based polymers are ethylene vinyl alcohol copolymer and cyclic olefin copolymer.

The lidding film may have a total composition including at least 80% polyolefin-based polymers, by weight. In other words, considering all materials (polymeric and non-polymeric) within the entire lidding film, at least 80% by weight are polyolefin-based polymers. The lidding film may have a total composition including a minimum polyolefin-based polymer content of 80%, 82%, 84%, 86%, 88% or 90%, by weight. The lidding film may have a total composition including a maximum polyolefin-based polymer content of 100%, 99%, 98%, 97%, 96% or 95%, by weight. For example, the lidding film may have a total composition having from 90% to 99% polyolefin-based polymer or the lidding film may have a total composition having from 82% to 100% polyolefin-based polymer, by weight.

As used herein, a “polypropylene-based polymer” refers to a homopolymer or copolymer having at least one propylene monomer linkage within the repeating backbone of the polymer. The propylene linkage can be represented by the general formula: [CH₂—CH(CH₃)]ₙ. Such polypropylene may be a polypropylene impact copolymer, a polypropylene random copolymer or a polypropylene homopolymer, may be syndiotactic or isotactic and/or may or may not be nucleated. A polypropylene-based polymer may be a propylene alpha-olefin copolymer.

The lidding film may have a total composition including at least 70% polypropylene-based polymers, by weight. In other words, considering all the materials (polymeric and non-polymeric) within the entire lidding film, at least 70% by weight are polypropylene-based polymers. The lidding film may have a total composition including a minimum polypropylene-based polymer content of 70%, 80%, 85%, 86%, 88% or 90%, by weight. The lidding film may have a total composition including a maximum polypropylene-based polymer content of 100%, 99%, 98%, 97%, 96% or 95%, by weight. For example, the lidding film may have a total composition having from 70% to 98% polypropylene-based polymer or the lidding film may have a total composition having from 80% to 100% polypropylene-based polymer, by weight.

In some embodiments, the lidding film has a total composition that includes less than 10% polymers other than polyolefin-based polymers, by weight. In addition to having high polyolefin and polypropylene content, the lidding film may have low levels of non-polyolefin polymers, with respect to the total composition. Non-polyolefin polymers that may be included in the lidding film include polyamides, polyacrylates and polyurethanes. These polymers may be present in an extruded layer or within a printed ink or adhesive layer. The lidding film may have a total composition that includes less than 9%, 8%, 7%, 6% or 5% polymers other than polyolefin-based polymers, by weight.

In some embodiments, the lidding film is free from polymers other than polyolefin-based polymers. In other words, any non-polyolefin polymers that may be present in the lidding film do not affect the basic and material properties of the film.

Referring now to FIG. 4, an embodiment of the lidding film 30 includes an exterior polypropylene-based film 32, a barrier layer 34, an interior polypropylene-based film 38, and a sealing layer 36. The sealing layer 36 is within a coextruded multilayer film 37. The exterior polypropylene-based film 32 may be located on one major surface of the lidding film and becomes the exposed outside surface of a package that may be formed from the lidding film. The sealing layer 36 is located on the other major surface of the lidding film and becomes the product contact side of a package that may be formed from the lidding film. The interior polypropylene-based film 38 and the barrier layer 34 are located interior to the surfaces of the lidding film 30. In some embodiments, the position of the interior polypropylene-based film 38 and the barrier layer 34 may be switched from the locations shown in FIG. 4. The lidding film may have a total composition including at least 80% polyolefin-based polymers, by weight. The lidding film has a total composition including at least 80% polypropylene-based polymers, by weight.

The barrier layer may be adjacent to or in contact with the interior surface of the exterior polypropylene-base film. The barrier layer may be adjacent to or in contact with either side of the interior polypropylene based film.

The interior polypropylene-based film may be oriented. The film may be biaxially oriented or mono-axially oriented in either direction. The interior polypropylene-based film is preferably heat set (i.e. annealed) such that it is dimensionally stable under elevated temperature conditions that might be experienced during conversion of the laminate or during the use of the laminate (i.e. heat sealing or retort sterilization). The interior polypropylene-based film, if present, may be the same or different than the exterior polypropylene-based film.

The interior polypropylene-based film may be an oriented polypropylene film, such as biaxially oriented polypropylene. The oriented polypropylene film may have one or more layers and may have specialized coatings, such as matte finish. Any of the layers of the oriented polypropylene film may contain a pigment, such as titanium dioxide, to make the film opaque to visible light. The film may be a cavitated biaxially oriented polypropylene, resulting in a film opaque to visible light. The biaxially oriented polypropylene may be clear to visible light. In some embodiments, the exterior polypropylene-based film is a biaxially oriented polypropylene film that essentially comprises polypropylene.

In embodiments that contain an interior polypropylene-based film, the interior polypropylene-based film may be the same as or different than the exterior polypropylene-based film. Commercial examples of films that may be used as the interior polypropylene-based film include Bicor™ NND20 (non-heat sealable, one side treated BOPP, available from Jindal Films), PL1 (non-heat sealable, one side treated BOPP, available from Polibak Plastik Film San. ve Tic. A.S.) and PPTE_LAM (non-heat sealable, one side treated, available from Poligal).

The barrier layer may be a coating or a deposition that is applied to one of the films used to build the lidding film. For example, the barrier layer 34 shown in the embodiment shown in FIG. 4 may be a silicon oxide material that has been deposited on the interior polypropylene-based film 38, positioned between the exterior polypropylene-based film 32 and the interior polypropylene-based film 38. Or, the barrier layer 34 shown in the embodiment shown in FIG. 4 may be a silicon oxide material that has been deposited on the exterior polypropylene-based film 32, positioned between the exterior polypropylene-based film 32 and the interior polypropylene-based film 38. Alternatively, the barrier layer 34 may be a silicon oxide material that has been deposited on the side of the interior polypropylene-based film 38 that is facing the sealing layer 36 (this embodiment is not shown in the Figures).

Any embodiments of the lidding film may contain other materials and layers. For example, the film structure may contain either extruded tie layers or other adhesive layers meant to bond dissimilar materials. The film may contain ink layers at any position of the structure.

In some embodiments of the lidding film, the exterior film, the interior film and the sealing layer are free from polymers other than polyolefin-based polymers.

### Examples & Data

A total of eight films were produced and tested. Six films were lidding films according to those films described herein, these films being labeled Example Films 1 through 6. Two films were comparative examples of lidding films, these films being labeled Comparative Example Films 1 and 2. Example Films 1 through 6 were recycle-ready lidding films and suitable for sterilization or pasteurization related packaging applications. Comparative Example Films 1 and 2 were used commercially as lidding films in sterilization or pasteurization related packaging applications but were not recycle-ready. The structures of all eight films are outlined in Table 1.

TABLE 1
Structures of Example Films 1 through
6 and Comparative Example Films 1 and 2

| | | Layer | Polyolefin | Polypropylene |
|---|---|---|---|---|
| Identifier | Structure | Wt (g/m²) | Wt (g/m²) | Wt (g/m²) |
| Example | BOPP1 | 22.75 | 22.75 | 22.75 |
| Film 1 | adhesive1 | 4 | 0 | 0 |
| | BOPP/SiOx | 16.4 | 16.3 | 15.6 |
| | adhesive1 | 4 | 0 | 0 |
| | multilayer film | 62.7 | 62.7 | 60.8 |
| | with PP sealing | | | |
| | layer | | | |
| | Total composition: | | 93% PO | 90% PP |
| Example | BOPP1 | 22.75 | 22.75 | 22.75 |
| Film 2 | adhesive1 | 4 | 0 | 0 |
| | BOPP/SiOx | 16.4 | 16.3 | 15.6 |
| | adhesive1 | 4 | 0 | 0 |
| | multilayer film | 49.0 | 49.0 | 0 |
| | with PE sealing | | | |
| | layer | | | |
| | Total composition: | | 92% PO | 40% PP |
| Example | BOPP1 | 22.75 | 22.75 | 22.75 |
| Film 3 | adhesive1 | 4 | 0 | 0 |
| | BOPP/SiOx | 18.1 | 16.3 | 16.3 |
| | adhesive1 | 4 | 0 | 0 |
| | multilayer film | 62.7 | 62.7 | 60.8 |
| | with PP sealing | | | |
| | layer | | | |
| | Total composition: | | 91% PO | 90% PP |
| Example | BOPP1 | 22.75 | 22.75 | 22.75 |
| Film 4 | adhesive1 | 4 | 0 | 0 |
| | BOPP/SiOx | 18.1 | 16.3 | 16.3 |
| | adhesive1 | 4 | 0 | 0 |
| | multilayer film | 45.4 | 45.4 | 44.0 |
| | with PP sealing | | | |
| | layer | | | |
| | Total composition: | | 90% PO | 88% PP |
| Example | BOPP1 | 22.75 | 22.75 | 22.75 |
| Film 5 | adhesive1 | 4 | 0 | 0 |
| | BOPP/SiOx | 18.8 | 16.3 | 16.3 |
| | adhesive1 | 4 | 0 | 0 |
| | multilayer film | 62.7 | 62.7 | 60.8 |
| | with PP sealing | | | |
| | layer | | | |
| | Total composition: | | 91% PO | 89% PP |
| Example | BOPP1 | 22.75 | 22.75 | 22.75 |
| Film 6 | adhesive2 | 4 | 0 | 0 |
| | BOPP/SiOx | 18.1 | 16.3 | 16.3 |
| | adhesive2 | 4 | 0 | 0 |
| | multilayer film | 66.9 | 62.1 | 59.6 |
| | with PP sealing | | | |
| | layer | | | |
| | Total composition: | | 87% PO | 85% PP |
| Comparative | OPET/AlOx | 16.8 | 0 | 0 |
| Example 1 | adhesive | 4.5 | 0 | 0 |
| | Cast PA | 28.3 | 0 | 0 |
| | adhesive | 4.5 | 0 | 0 |
| | multilayer film | 45.4 | 45.4 | 44.0 |
| | with PP sealing | | | |
| | layer | | | |
| | Total composition: | | 46% PO | 44% PP |
| Comparative | OPET/AlOx | 16.8 | 0 | 0 |
| Example 2 | adhesive | 4.5 | 0 | 0 |
| | Cast PA | 28.3 | 0 | 0 |
| | adhesive | 4.5 | 0 | 0 |
| | multilayer film | 62.7 | 62.7 | 60.8 |
| | with PP sealing | | | |
| | layer | | | |

| | | |
|---|---|---|
| Total composition: | 54% PO | 52% PP |

OPP1 = 25 micron biaxially oriented polypropylene film containing 100% homopolymer polypropylene
adhesive1 = two-component Loctite Liofol ® adhesive LA3644 and hardener LA6055, available from Henkel
adhesive 2 = two-component adhesive system of Dow Adcote ™ 811A and Catalyst 9L10, available from Dow Chemical
Example Films 1 through 6 each had the BOPP/SiOx film oriented with the SiOx side of the material laminated to the exterior BOPP film and the BOPP side of the material laminated to the multilayer film containing the sealing layer

Samples of Example Films 1 and 2 were completely submerged in a hydrogen peroxide bath. The bath was heated to 60° C. and maintained at this temperature for one hour, followed by a four-hour period during which heating was stopped and the bath could cool to room temperature. No visual changes in the film samples were observed indicating suitability for peroxide sterilization.

The burst strength of the Example Films 1 through 6 and another typical non-recyclable lidding film, Comparative Example Film 1. Films were tested using a Lorentzen and Wettre Bursting Strength Tester and ISO 2758:2014. Each sample was tested three times and the average burst strength is reported in Table 2. The burst strength of Example Films 1 through 6 was considerably higher than the Comparative Example Film 1.

TABLE 2
Burst Strength on Flat Film Examples

| | Average Burst Strength | Average Burst Strength |
|---|---|---|
| | (kPa); seal layer facing | (kPa); seal layer facing |
| Identifier | toward membrane | away from membrane |
| Example 1 | 788.7 | 788.0 |
| Example 2 | 809.6 | 806.2 |
| Example 3 | 736.3 | 725.4 |
| Example 4 | 748.3 | 768.7 |
| Example 5 | 719.7 | 720.7 |
| Example 6 | 863.7 | 801.0 |
| Comparative | 423.0 | 420.2 |
| Example 1 | | |

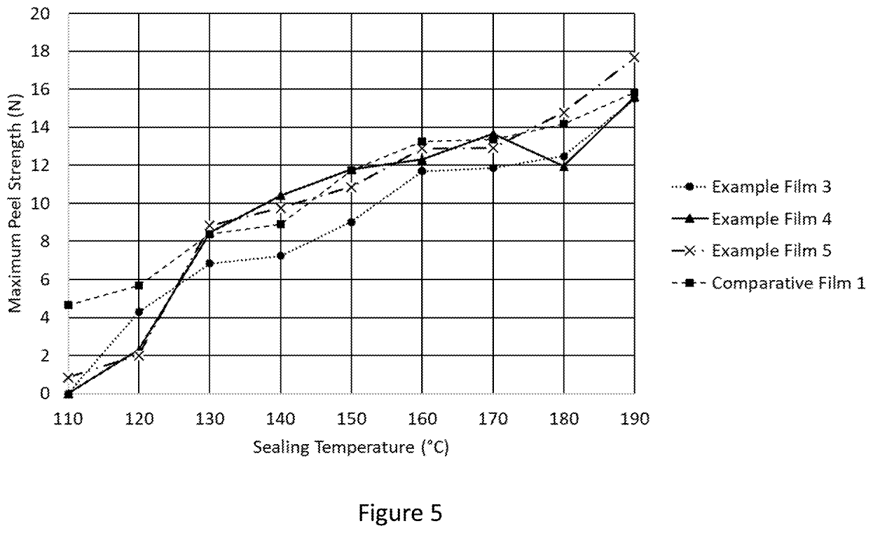

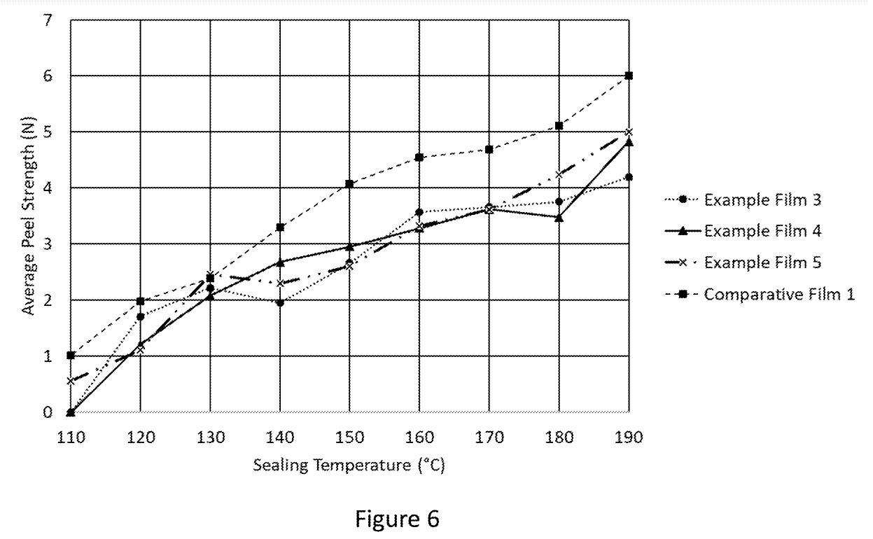

The sealing and peeling performance of the films was tested using a method that heat seals the lidding film to a pre-formed rigid cup having a structure of polypropylene/EVOH/polypropylene. These types of cup and lid arrangements are typically used for packaging pieces of fruit with syrup or similar products. The lids were heat sealed to the empty cups by a tray sealer with circular sealing jaws adjusted to the diameter of the round cups at various sealing temperatures. After cooling, the packages were loaded into a tensile testing unit that allows the lid to be peeled by a dragged clamp at an angle between 0 degrees and 90 degrees (about 30 degrees to 45 degrees). The maximum and average peel strength is recorded as the lid is removed. The maximum peel strength typically occurs at the first moment of opening and the average peel strength takes into consideration the force required throughout the propagation of peeling over the entire seal. FIGS. 5 and 6 show the maximum and average peel strength curves, respectively, over a sealing temperature range of 110° C. to 190° C.

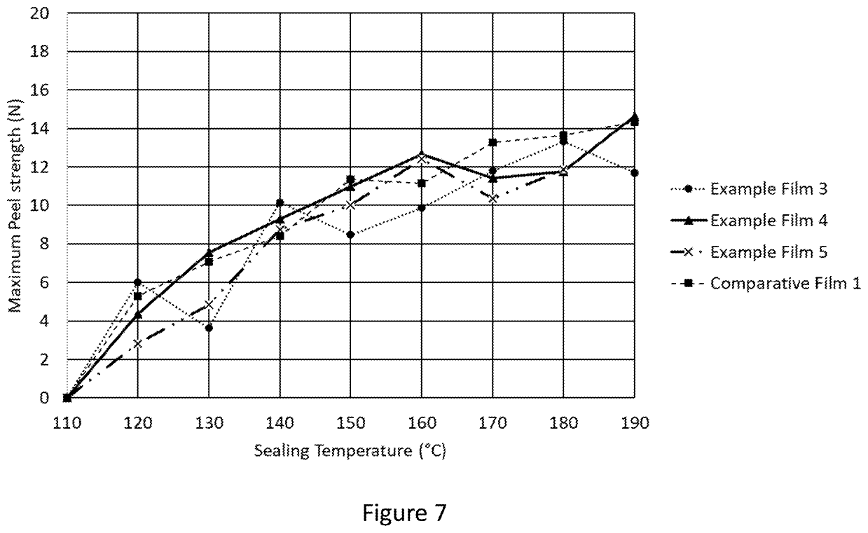

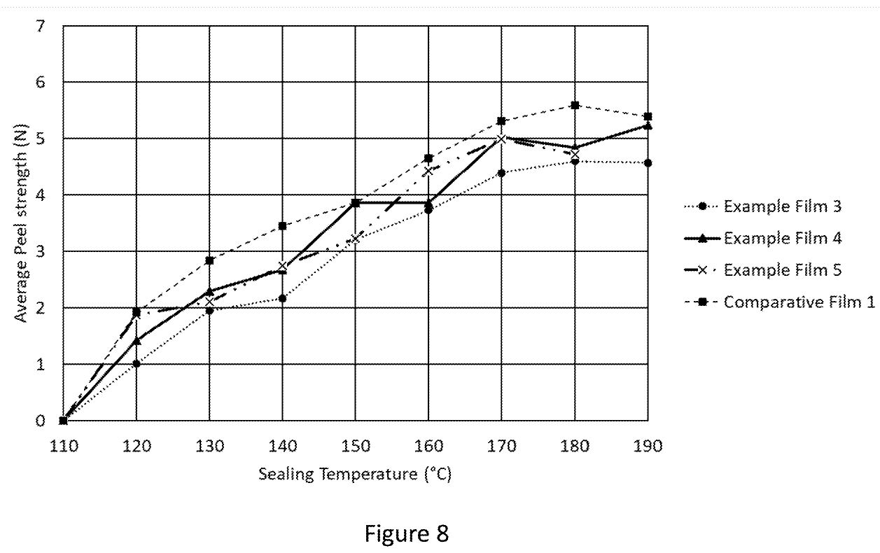

Additionally, sealed cups were also exposed to a water bath at 85° C. for 30 minutes to mimic the heat environment of a pasteurization process. After being removed from the water bath, the cups were cooled and then again, the peel strength measured. FIGS. 7 and 8 show the maximum and average peel strength curves, respectively of the heat-treated cups over a sealing temperature range from 110° C. to 190° C.

The oxygen transmission of the Example Films and Comparative Example Films were tested in multiple ways and the results of the testing are reported in Table 3. Flat samples of the films were tested according to ASTM F1927 using conditions of 23° C. and 50% RH (Flat Sample OTR). Flat samples of the films were similarly tested after a heat treatment (Post Heating Flat Sample OTR). The heat treatment for Example Films 1 through 5 was a water bath at 85° C. for 30 minutes. The heat treatment for Example Film 6 was an autoclave process at 121° C. for 30 minutes.

Additionally, the films were hermetically sealed to the lid of a polypropylene cup that was filled with water and the filled and sealed cups were exposed to a heat treatment. The heat treatment for the cups having lidding made of Example Films 1 through 5 and Comparative Example 2 was a water bath at 85° C. for 30 minutes and the heat treatment for the cup having lidding made of Example Film 6 was an autoclave process at 121° C. for 30 minutes. After the heat treatment, the lids were peeled from the cups and the flat samples were tested for oxygen transmission rate according to ASTM F1927 (Post Heating Cup Format OTR) at conditions of 23° C. and 0% RH.

TABLE 3
Oxygen Transmission Testing (OTR) Results for Lidding Films

| | | Post Heating Flat | Post Heating Cup |
|---|---|---|---|
| | Flat Sample OTR | Sample OTR | Format OTR |
| Identifier | (cc/m² day) | (cc/m² day) | (cc/m² day) |
| Comparative | 0.1 | — | 1.57 |
| Example 2 | | | |
| Example 1 | 0.09 | 0.13 | — |
| Example 2 | 0.07 | < | 1.44 |
| Example 3 | 0.14 | 0.28 | 2.02 |
| Example 4 | 0.13 | 0.20 | 1.77 |
| Example 5 | 0.02 | 0.03 | 1.46 |
| Example 6 | — | — | 2.50 |

‘—’ indicates that the sample was not tested
‘<’ indicates that the measurement was below the test unit detection limit

The lidding films described herein and shown in the examples are recycle-ready and stable in an aseptic peroxide bath making them suitable for such an aseptic process. Using these structures, superior burst strength as compared to typical non-recyclable structures used for the same application can be achieved. In addition the recycle-ready lidding film structures offer the possibility to seal at relatively low temperature on PP-based containers. To achieve recyclability the structures are changed from a conventional structure to a polyolefin-based structure and can withstand a heat treatment such as sterilization or pasteurization with good barrier retention. The products packaged using such lidding films maintain similar long product shelf-life such as the non-recyclable structures use for such application today.

### EMBODIMENTS

A. A lidding film comprising:
   an exterior polypropylene-based film,
   a barrier layer, and
   a sealing layer,
wherein the lidding film has a total composition comprising at least 80% polyolefin-based polymers by weight.
B. The lidding film according to any previous embodiment wherein the exterior polypropylene-based film is oriented.
C. The lidding film according to any previous embodiment wherein the exterior polypropylene-based film comprises a homopolymer polypropylene.
D. The lidding film according to any previous embodiment wherein the barrier layer comprises a metal.
E. The lidding film according to any previous embodiment wherein the barrier layer comprises an inorganic oxide.
F. The lidding film according to any previous embodiment wherein the lidding film has a total composition comprising at least 80% polypropylene-based polymers by weight.
G. The lidding film according to any previous embodiment wherein the lidding film has a total composition comprising at least 90% polyolefin-based polymers by weight.
H. The lidding film according to any previous embodiment wherein the sealing layer is a peelable sealing layer.
I. The lidding film according to any previous embodiment wherein the sealing layer comprises a polypropylene-based polymer.
J. The lidding film according to any previous embodiment further comprising an interior polypropylene-based film and wherein the interior polypropylene-based film is oriented.
K. A package comprising the lidding film according to any of embodiments A-J, a second packaging component, a heat seal connecting the sealing layer of the lidding film to a surface of the second packaging component and a product hermetically sealed between the lidding film and the second packaging component, wherein the product has undergone a sterilization process.
L. A package comprising the lidding film according to any of embodiments A-J, a second packaging component, a heat seal connecting the sealing layer of the lidding film to a surface of the second packaging component and a product hermetically sealed between the lidding film and the second packaging component, wherein the product has undergone a pasteurization process.
M. A package comprising the lidding film according to any of embodiments A-J, a second packaging component, a heat seal connecting the sealing layer of the lidding film to a surface of the second packaging component and a product hermetically sealed between the lidding film and the second packaging component, wherein the lidding film has undergone a sterilization process.
N A package comprising the lidding film according to any of embodiments A-J, a second packaging component, a heat seal connecting the sealing layer of the lidding film to a surface of the second packaging component and a product hermetically sealed between the lidding film and the second packaging component, wherein the lidding film has undergone a pasteurization process.
O. The package according to any of embodiments K-N wherein the heat seal is manually peelable.
P. The package according to any of embodiments K-N wherein the surface of the second packaging component comprises a polypropylene-based polymer.
Q. The package according to any of embodiments K-P wherein the package has a total composition comprising at least 80% polyolefin-based polymers, by weight.
R. The package according to any of embodiments K-Q wherein the package has a total composition comprising at least 80% polypropylene-based polymers, by weight.
S. The package according to any of embodiments K-R wherein the package has a total composition comprising at least 90% polypropylene-based polymers, by weight.
T. The package according to any of embodiments K-S wherein the lidding film has an oxygen transmission value less than 3.0 cc/m² day when measured according to ASTM F1927 at conditions of 23° C. and 50% RH.
U. A lidding film comprising:
   an exterior polypropylene-based film,
   an interior polypropylene-based film,
   a barrier layer comprising an inorganic oxide, and
   a sealing layer,
wherein the interior polypropylene-based film is oriented,
wherein the exterior polypropylene-based film is oriented and comprises a homopolymer polypropylene, and
wherein the lidding film has a total composition comprising at least 80% polypropylene-based polymers by weight and is effective to survive sterilization.

What is claimed is:

1. A lidding film comprising:
an exterior polypropylene-based film,
a barrier layer, and
a sealing layer,
wherein the lidding film has a total composition comprising at least 80% polyolefin-based polymers by weight.

2. The lidding film according to claim 1 wherein the exterior polypropylene-based film is oriented and the exterior polypropylene-based film comprises a homopolymer polypropylene.

3. The lidding film according to claim 1 wherein the barrier layer comprises a metal.

4. The lidding film according to claim 1 wherein the barrier layer comprises an inorganic oxide.

5. The lidding film according to claim 1 wherein the lidding film has a total composition comprising at least 80% polypropylene-based polymers by weight.

6. The lidding film according to claim 1 wherein the lidding film has a total composition comprising at least 90% polyolefin-based polymers by weight.

7. The lidding film according to claim 1 wherein the sealing layer is a peelable sealing layer.

8. The lidding film according to claim 1 wherein the sealing layer comprises a polypropylene-based polymer.

9. The lidding film according to claim 1 further comprising an interior polypropylene-based film and wherein the interior polypropylene-based film is oriented.

10. A lidding film comprising:
an exterior polypropylene-based film,
an interior polypropylene-based film,
a barrier layer comprising an inorganic oxide, and
a sealing layer,
wherein the interior polypropylene-based film is oriented,
wherein the exterior polypropylene-based film is oriented and comprises a homopolymer polypropylene, and
wherein the lidding film has a total composition comprising at least 80% polypropylene-based polymers by weight and is effective to survive sterilization.

11. A package comprising the lidding film according to claim 1, a second packaging component, a heat seal connecting the sealing layer of the lidding film to a surface of the second packaging component and a product hermetically sealed between the lidding film and the second packaging component, wherein the product has undergone a sterilization process.

12. A package comprising the lidding film according to claim 1, a second packaging component, a heat seal connecting the sealing layer of the lidding film to a surface of the second packaging component and a product hermetically sealed between the lidding film and the second packaging component, wherein the product has undergone a pasteurization process.

13. A package comprising the lidding film according to claim 1, a second packaging component, a heat seal connecting the sealing layer of the lidding film to a surface of the second packaging component and a product hermetically sealed between the lidding film and the second packaging component, wherein the lidding film has undergone a sterilization process.

14. A package comprising the lidding film according to claim 1, a second packaging component, a heat seal connecting the sealing layer of the lidding film to a surface of the second packaging component and a product hermetically sealed between the lidding film and the second packaging component, wherein the lidding film has undergone a pasteurization process.

15. The package according to claim 11 wherein the heat seal is manually peelable.

16. The package according to claim 11 wherein the surface of the second packaging component comprises a polypropylene-based polymer.

17. The package according to claim 11 wherein the package has a total composition comprising at least 80% polyolefin-based polymers, by weight.

18. The package according to claim 11 wherein the package has a total composition comprising at least 80% polypropylene-based polymers, by weight.

19. The package according to claim 17 wherein the package has a total composition comprising at least 90% polypropylene-based polymers, by weight.

20. The package according to claim 11 wherein the lidding film has an oxygen transmission value less than 3.0 cc/m² day when measured according to ASTM F1927 at conditions of 23° C. and 50% RH.
